(19) United States
(12) Patent Application Publication
(10) Pub. No.: US 2016/0042464 A1
(43) Pub. Date: Feb. 11, 2016

(54) REPLACEMENT INSURANCE POLICY EXCHANGE

(71) Applicant: COMMUNICATION INTELLIGENCE CORP., Redwood Shores, CA (US)

(72) Inventor: Katherine Dease, Vestavia Hills, AL (US)

(73) Assignee: COMMUNICATION INTELLIGENCE CORP., Redwood Shores, CA (US)

(21) Appl. No.: 14/455,425

(22) Filed: Aug. 8, 2014

(51) Int. Cl. G06Q 40/08

(52) U.S. Cl. CPC G06Q 40/08

(57) ABSTRACT

A process for insurance policy exchange. A client has a ceding carrier's issued policy and a distributor has a replacement policy application. The distributor has placed an order for the replacement policy with a gaining carrier. The gaining carrier employs an insurance exchange system dashboard to construct and place a relinquishment request to the ceding carrier. This informs the ceding carrier about the order and includes signed transfer request and other needed forms for the exchange. The gaining carrier reviews the relinquishment request to determine whether to approve or reject it. Then the ceding carrier employs the insurance exchange system dashboard to construct and place a disposition to the gaining carrier. This disposition includes an approval or a rejection of the relinquishment request. The insurance exchange system dashboard is a server computerized system hosted on a global communications network and provides templates for constructing the relinquishment request and the disposition.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### COPYRIGHT NOTICE AND PERMISSION

This document contains some material which is subject to copyright protection. The copyright owner has no objection to the reproduction with proper attribution of authorship and ownership and without alteration by anyone of this material as it appears in the files or records of the Patent and Trademark Office, but otherwise reserves all rights whatsoever.

### BACKGROUND OF THE INVENTION

1. Technical Field

The present invention relates generally to electronic communications, and more particularly to electronic document exchange in the insurance industry.

2. Background Art

In the course of their affairs it is not uncommon for the holder of an insurance policy holder to want to change insurance carriers. FIG. 1 (background art) is a block diagram that stylistically shows a traditional replacement policy exchange. A policy holder, which may generally be termed a “client” has an existing insurance policy. This policy was issued by an insurance carrier, which we generally term a “ceding carrier” for this discussion. The client has requested to replace the policy, allowing the distributor to submit an application for a replacement insurance policy. [Distributors are sometimes termed “broker/dealers” or “BDs.” The definition here includes any use by someone submitting the initiation paperwork for the exchange, including: Agents, Agencies, Brokerage General Agencies (BGAs), and Independent Marketing Organizations IMOs).]. The client will sign the required transfer paperwork.

The distributor has prepared an order for a replacement insurance policy and submitted it to another insurance carrier, which we generally term a “gaining carrier” for this discussion. The gaining carrier has then prepared appropriate relinquishment request documents and sent them to the ceding carrier. The ceding carrier will have to relinquish send the original contract funds to the gaining carrier. And if the gaining carrier accepts the order, it may employ the Depository Trust & Clearing Corporation (DTCC) to handle the money settlement to move the money from the ceding carrier to the gaining carrier.

The replacement policy process above has been described simplistically. In actual practice, it can be very complex, can take considerable time, and many problems can be encountered. For example, having made the decision to apply for a replacement policy, the (policy holder) client will typically want the replacement policy to issue quickly.

The distributor usually has similar concerns. Having “made the sale,” they will want to wrap-up the work they need to do, to get paid, and to keep the client happy. To do this, however, the distributor has to see that the application is “in good order” (a phrase often replaced with the acronym “IGO” in the industry), or to promptly correct matters when an application is “not in good order” (“NIGO” in the industry). Next, the distributor has to prepare an order for the replacement policy. The distributor may work with a single insurance carrier, in which case selecting the gaining carrier will be simple, or the distributor may work with multiple insurance carriers and selecting the gaining carrier may require considerable effort. Multiple iterations of order preparation, IGO/NIGO review, and revision may be necessary. Once their order is complete and IGO, the distributor submits it to the gaining carrier.

The gaining carrier usually also has similar concerns. They want to wrap-up the work they need to do, to get the replacement policy issued and generating premium income, and to keep the distributor and the client happy. To do this, however, the gaining carrier has to see that the order is IGO, or work promptly with the distributor to remedy why it is NIGO. Then the gaining carrier has to deal with the ceding carrier, informing them of the client's desire to cancel the existing policy with the ceding carrier in favor of a replacement policy to be issued by the gaining carrier.

The ceding carrier has mixed concerns. It faces the prospect of losing the client and income from the existing policy. The ceding carrier may therefore want to attempt “conservation,” a process where it tries to convince the client to change its mind and keep the existing policy (or replace it with another product of the ceding carrier). To do this requires time, since the ceding carrier has to engage in some manner of dialog with the client to determine why the client wants to leave (e.g., policy cost, policy features, quality of service, personal reasons, etc.). Then the ceding carrier has to determine whether it can conserve (e.g., the client may have a familial relationship with an agent of the distributor and thus simply be unwilling to change their mind). Then the ceding carrier has to determine whether it wants to conserve (e.g., it may deem conservation counterproductive due to low profit). At some point the matter of conservation will be settled, but the ceding carrier may want or need time to reach this point. Conversely, the ceding carrier does not want to unduly delay reaching this point, because the client, distributor, gaining carrier, and industry regulators may object to undue delay. A ceding carrier therefore typically considers conservation promptly, often in parallel with handling the other documents received from the gaining carrier.

Aside from conservation considerations, the ceding carrier needs to also consider matters related to the documents received from the gaining carrier. A first typical consideration is whether those documents are IGO/NIGO. A subsequent major concern may be if and in what amount the ceding carrier has to pay recoupment funds to the gaining carrier. For example, the existing policy may have been paid for in full but only be two months into a 12 month policy term. Analysis related to recoupment can be very complex. For instance, it may start with the “clear” language of the terms in the written policy, which may not be entirely clear. It may then continue with whether any changes in industry standards, legal statutes, regulatory agency edicts, etc. apply. Of course, this can all be complicated and multiplied if the existing insurance policy has applicability in multiple jurisdictions. Then whether any choice of law terms exist or are valid may also apply. Etc. At some point the matters of ceding carrier processing and the amount of recoupment payment will also be settled, and the ceding carrier then communicates a disposition of the relinquishment request to the gaining carrier.

The gaining carrier now usually has ongoing expediency concerns. It wants to void the order if the ceding carrier was successful with conservation, or to otherwise complete the order processing and issuance for the new policy. If the replacement policy is being issued, the gaining carrier can optionally initiate money settlement using the Depository Trust & Clearing Corporation (DTCC) to assist in the movement of the money from the ceding carrier to the gaining carrier. The DTCC is widely used in the industry, and frequently handles such matters, but the ceding carrier can always instead directly pay the gaining carrier and/or directly advise it of matters.

The above discussion serves to introduce some of the considerations related to complexity, delay, and potential problems in replacement insurance policy exchange. In summary, traditional replacement insurance policy exchange is very disjointed, manual, and slow. It is therefore in the general interest of the entities described above, and sometimes others as well, to adopt new tools that will improve replacement insurance policy exchange.

### BRIEF SUMMARY OF THE INVENTION

Accordingly, it is an object of the present invention to provide an improved replacement insurance policy exchange.

Briefly, one preferred embodiment of the present invention is a process for insurance policy exchange. A client has an existing policy issued by a ceding carrier and a distributor has an application from the client for a replacement policy to replace the existing insurance policy. The distributor employs an insurance exchange system dashboard to construct and place an order for the replacement policy to a gaining carrier. This order includes the signed client transfer forms and replacement policy details. The gaining carrier reviews the replacement policy details to determine whether to accept the order. The gaining carrier employs the insurance exchange system dashboard to construct and place a relinquishment request to the ceding carrier. This relinquishment request informs the ceding carrier that the gaining carrier has the order for the replacement policy and includes the the signed client transfer forms. The ceding carrier reviews said relinquishment request to determine whether to approve or reject the relinquishment request. The ceding carrier employs the insurance exchange system dashboard to construct and place a disposition to the gaining carrier. This disposition includes an approval or a rejection of the relinquishment request. The gaining carrier reviews the disposition and accepts the order from the distributor if said disposition includes an approval, or rejects the order from the distributor if the disposition includes a rejection. The gaining carrier communicates to the distributor the accepting or the rejecting of the order. The insurance exchange system dashboard is a server computerized system hosted on a global communications network and provides templates for constructing the order, the relinquishment request, and the disposition.

Briefly, another preferred embodiment of the present invention is a process for insurance policy exchange. A client has an existing policy issued by a ceding carrier and a distributor has an application from the client for a replacement policy to replace the existing insurance policy. The distributor has placed an order for the replacement policy with a gaining carrier. The gaining carrier employs an insurance exchange system dashboard to construct and place a relinquishment request to the ceding carrier. This relinquishment request informs the ceding carrier that the gaining carrier has the order for the replacement policy and includes the signed client transfer forms. The ceding carrier reviews the relinquishment request to determine whether to approve or reject the relinquishment request. The ceding carrier employs the insurance exchange system dashboard to construct and place a disposition to the gaining carrier. This disposition includes an approval or a rejection of the relinquishment request. The insurance exchange system dashboard is a server computerized system hosted on a global communications network and provides templates for constructing the relinquishment request and the disposition.

And briefly, another preferred embodiment of the present invention is a computer program for insurance policy exchange when a client has an existing policy issued by a ceding carrier and a distributor has an application from the client for a replacement policy to replace the existing insurance policy, and when the distributor has placed an order for the replacement policy with a gaining carrier. Included is a code segment that permits the gaining carrier to employ the insurance exchange system dashboard to construct and place a relinquishment request to the ceding carrier, wherein said relinquishment request informs the ceding carrier that the gaining carrier has the order for the replacement policy and includes the signed client transfer forms. Further included is a code segment that permits the ceding carrier to review said relinquishment request to determine whether to approve or reject said relinquishment request. And further included is a code segment that permits the ceding carrier to employ the insurance exchange system dashboard to construct and place a disposition to the gaining carrier, wherein said disposition includes an approval or a rejection of said relinquishment request. The insurance exchange system dashboard is a server computerized system hosted on a global communications network and provides templates for constructing the relinquishment request and the disposition.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE SEVERAL VIEWS OF THE DRAWING(S)

The purposes and advantages of the present invention will be apparent from the following detailed description in conjunction with the appended figures of drawings in which:

FIG. 1 (background art) is a block diagram that stylistically shows a traditional replacement policy exchange.

FIG. 2 is a stylized block diagram of a cloud-based dashboard or console (the insurance exchange system dashboard or the “IESD” herein, also termed simply the “iSign Exchange”) that the present inventor has developed.

FIG. 3 is a flowchart showing an overview of a replacement policy process employing the IES and IESD.

FIG. 4 is a flowchart showing an overview of a major step in the replacement policy process in FIG. 3, shown here in FIG. 4 as a sub-process particularly employing the IESD.

FIG. 5 is a stylized block diagram that recaps and shows an overview of post sale workflow in the IESD.

FIG. 6 shows a participating entity user's view of a login screen of an exemplary embodiment the IESD.

FIG. 7 shows an entity user's view of a operational screen of the embodiment the IESD in FIG. 6, once a participating entity has logged in or once a non-participating entity has activated a link for entry.

FIG. 8 shows an alternate view of the operational screen, here once the packages tab is active.

FIG. 9 shows an alternate view of the operational screen, in the packages tab, now with two pop-up windows active.

FIG. 10 shows a non-participating entity view of an exemplary message received via the IESD through e-mail.

FIGS. 11a-b show pop-up status views overlying the operational screen with the packages tab active in the IESD.

In the various figures of the drawings, like references are used to denote like or similar elements or steps.

### DETAILED DESCRIPTION OF THE INVENTION

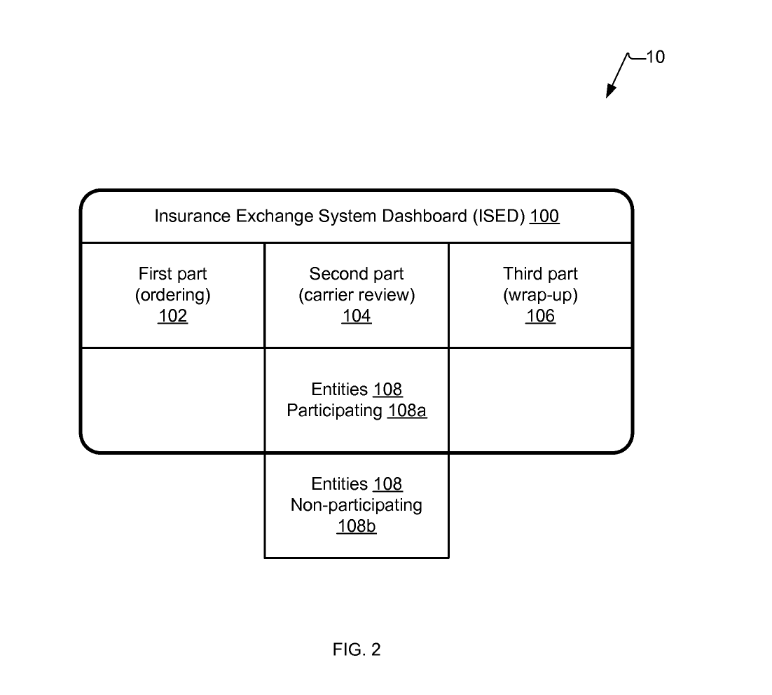

A preferred embodiment of the present invention is an improved replacement insurance policy exchange. As illustrated in the various drawings herein, and particularly in the views of FIGS. 2-4, an embodiment of the invention is depicted by the general reference character 100.

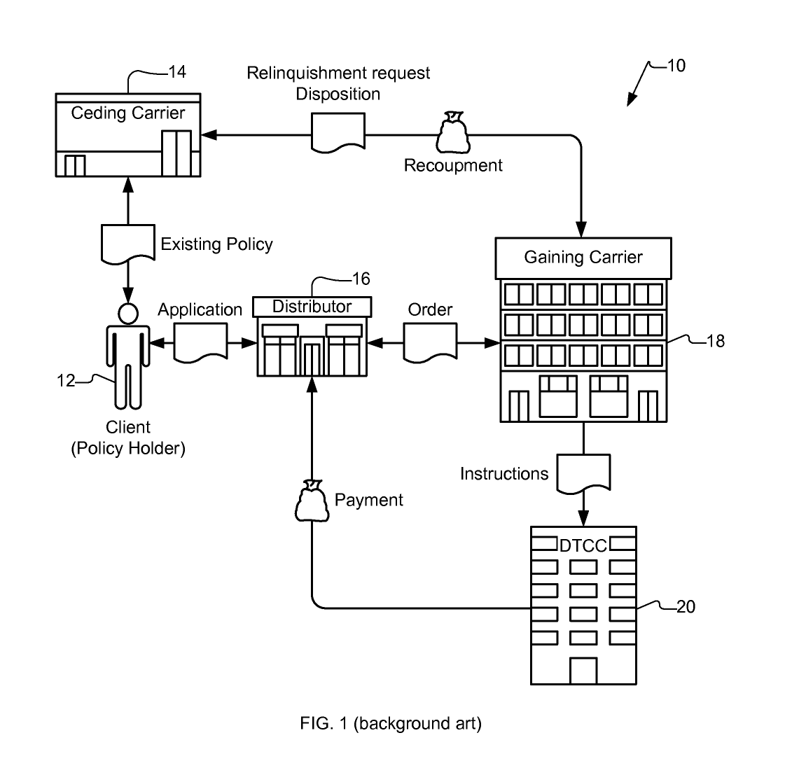

Returning briefly to FIG. 1 (background art), this includes references for the major entities that may employ an insurance exchange system (the “IES 10”). Specifically, these are: a client 12, the policy holder of an existing insurance policy; a ceding carrier 14, the insurance carrier that issued the existing policy; a distributor 16, an entity that has an application from the client 12 for a new insurance policy to replace the existing insurance policy; a gaining carrier 18, an insurance carrier that may accept an order from the distributor for the new insurance policy; and the DTCC 20, the Depository Trust & Clearing Corporation, which describes itself as a “post-trade market infrastructure for the global financial services industry.”

Briefly, as shown in the stylized block diagram in FIG. 2, the present inventor has developed a cloud-based dashboard or console (the insurance exchange system dashboard or the “IESD 100” herein, also termed simply the “iSign Exchange”). The IESD 100 can optionally be used in much of an overall IES 10, as particularly shown in FIG. 2. In particular, the IESD 100 can be used in the complex carrier review portion of the IES 10. The IESD 100 improves the IES 10 by treating it as having three parts. The first part 102 is order entry and application completion, the second part 104 is carrier review, and the third part 106 is electronic delivery and wrap-up.

The IESD 100 is used by entities 108, which may be participating entities 108a or non-participating entities 108b. The clients 12, ceding carriers 14, distributors 16, gaining carriers 18, DTCC 20, and yet others are all potential entities 108.

In the first part 102, participating entities 108a have direct access to the dashboard of the IESD 100 for order entry and application completion. Nonetheless, non-participating entities 108b can also use the IESD 100 to load forms, tag them, and send them to other entities 108 to complete and sign. For this the non-participating entities 108b typically use a link received in an e-mail, text message, etc. that is received from a participating entity 108a, to permit access to documents and features in the IESD 100.

In the second part 104, the IESD 100 allows a gaining carrier 18 and a ceding carrier 14 to review and approve documents in a dashboard with configurable workflow based on the appropriate review and approval process for the transaction. At least one of these, typically the gaining carrier 18, is a participating entity 108a. The IESD 100 can receive documents manually or via web service calls which can be sent to different entities 108 for review, edits (e.g., redlines), additional attachments, approval/rejection, signatures, and comments. The IESD 100 thus becomes an one-stop-shop for the exchange of documents in a secure portal. Very importantly, the IESD 100 does not exclude non-participating entities 108b.

The participating entities 108a can easily access transactions for review in the IESD 100. From there, the entities 108 can open links to view documents, edit them using provided tools, send comments back to other entities 108, reject an order with comments, and approve an order.

The non-participating entities 108b can still review documents, however, they will complete their review by accessing a secure link sent to them (e.g., via email). Upon accessing the link, a non-participating entity 108b can then have the same processes and options available (e.g., to edit, approve, reject, add comments, attach documents, signatures,etc.) as does a participating entity 108a. This is an important benefit of the invention, as both participating entities 108a and non-participating entities 108b can use the IESD 100.

The participating entities 108a now advantageously have control for the exchange of forms, data, and comments and they no longer have to track emails, facsimiles, and couriered documents, etc. The dashboard of the IESD 100 is the site to initiate and track packages as well as to edit, add comments, and approve or reject transactions by another entity 108. Reviewing entities 108 can add comments back to an originating entity 108 to allow for open communication during review, and such comments can be stored in an order audit detail in a comment section.

Additionally unique to this solution is the ability for a reviewing entity 108 to forward the transaction to another entity 108 for additional review. This is important to entities 108 that need another division to approve an order (e.g., where ceding carriers 14 send contracts internally for conservation).

If a review is rejected, the IESD 100 allows for the replacement of forms or edits to the forms and then resubmission. Information about all of this can be stored in an audit detail and remain part of the same order.

A set-up process for the IESD 100 can also uniquely permit participating entities 108a to select appropriate templates of other participating entities 108a for new transactions. The use of such templates helps to ensure that the correct form is being used and the correct data is captured. Additionally, the participating entity 108a can select another participating entity 108a in a drop-down for the exchange of data or they can manually add another entity 108. The drop down list for selection will come from the list of participating entities 108a and from a manual list that a participating entity 108a can create to make transacting business with non-participating entities 108b easier. The participating entities 108a have the ability to load or manually create a participant list of entities 108 to be available in the drop-down. If an entity 108 selected from the drop-down is a participating entity 108a, the IESD 100 can mirror that transaction in the dashboard as seen by the other entity 108. This particularly permits the IESD 100 dashboard to support a multi-entity transaction view. The workflow for which an entity 108 has rights to act on the order will follow the defined workflow that was set-up at the start. Application Programming Interfaces (APIs) can be made available for downloading the order documents, status, and comments.

Upon approval of all entities 108, events in an order can kick-off an event notification to the entities 108 noted in set-up of the IESD 100. If an entity 108 is a DTCC participant (e.g., a distributor 16), the event notification can be sent to the DTCC 20 to trigger money settlement.

Finally, in the third part 106, a participating entity 108a (e.g., distributor 16 or gaining carrier 18) can send the new contract to the client 12 for secure delivery and signature receipt using the IESD 100.

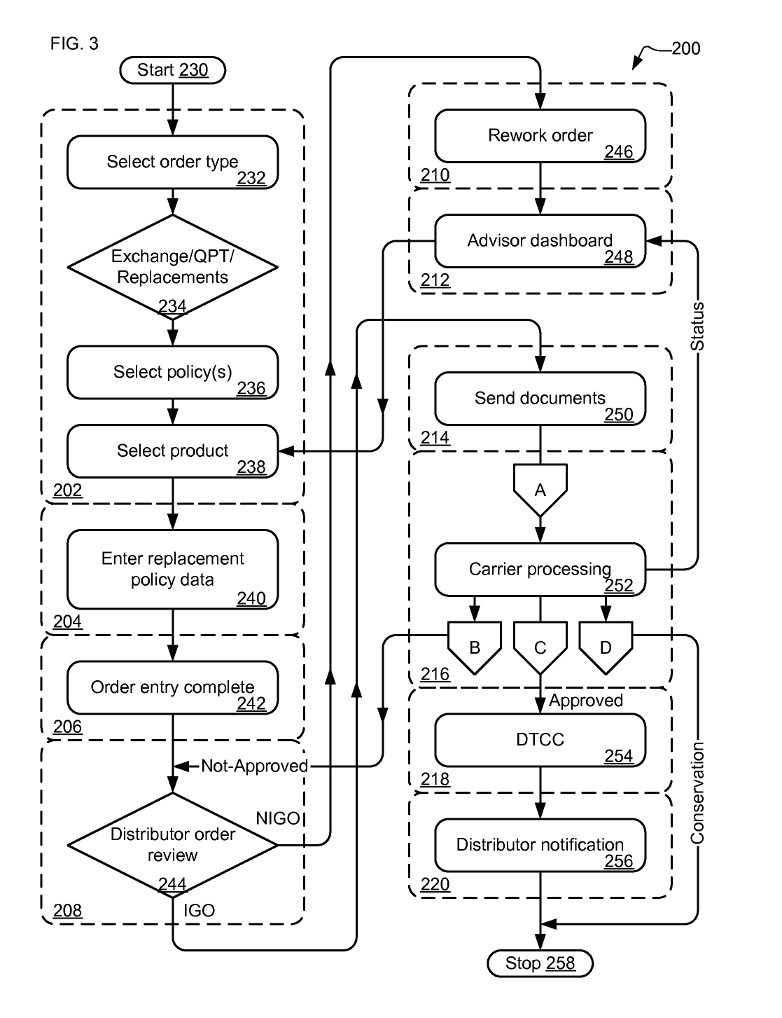

FIG. 3 is a flowchart showing an overview of a replacement policy process 200 employing the IES 10 and inventive the IESD 100. For the sake of this discussion, the process 200 is depicted here as having a set of major stages that are each performed by the various entities noted. These are stage 202 through stage 220. Stage 202 is replacement policy entry, performed by the distributor 16. Stage 204 is ceding policy entry, performed by the distributor 16. Stage 206 is suitability determination, performed by the distributor 16. Stage 208 is distributor review, performed by the distributor 16. Stage 210 is order rework, performed by the gaining carrier 18. Stage 212 is status reporting in an advisor dashboard. This is shown here at the distributor 16, but an important benefit of the IESD 100 is that its dashboard may fill this role and be accessible by the involved entities 108, as appropriate. Stage 214 is document conveying, from the distributor 16 to the gaining carrier 18. Stage 216 is carrier processing, performed by the gaining carrier 18. Stage 218 is DTCC processing, performed by the DTCC 20. And stage 220 is notification by the DTCC 20 to the distributor 16. The IESD 100 is particularly employed in stage 216, as discussed in detail presently.

The process 200 and its stages 202-220 are further depicted as having various steps (e.g., steps 230-258, as shown). The stages can include single steps, multiple steps, or even be optional. Those of ordinary skill in the art, here particularly including those in the insurance industry, will appreciate that the demarcations between the various stages and steps here are somewhat arbitrarily drawn, and that fewer or additional stages and steps may also be employed without deviating from the spirit of the present invention.

The process 200 begins in step 230, where any pre-process work and desired initialization are preformed. Stage 202 (replacement policy entry) is then performed by the distributor 16 and comprises steps 232-238. In step 232 the distributor 16 selects an order type appropriate for the application from the client 12. In step 234 the distributor 16 analyzes the order type to ensure that it is correct. [Here step 234 might conceptually be viewed as part of step 232, but is instead depicted separately for completeness. Although not particularly relevant to the present invention, typing the order as an exchange, qualified (versus taxable non-qualified), or as a replacement is important in the context of replacement insurance policy exchange.] In step 236 the distributor 16 selects one or more new policies. And in step 238 the distributor 16 selects a product, i.e., a policy offered by the gaining carrier 18.

In present industry practice, operations equivalent to those in stage 202 may require appreciable time to perform (e.g., half a day) and problems can be encountered, such as the lack of ceding carrier information. In addition to developing the IESD 100, the present inventor's company provides document handling products and services that can be used to save time and reduce or eliminate problems throughout the IES 10. For example, these products can provide templates to facilitate the selections made, and these services can include providing cloud based tools to permit the various entities to intercommunicate, to exchange documents, to sign documents, and to collect audit data throughout the process 200.

Stage 204 (replacement policy entry) comprises step 240. In step 240 the distributor 16 enters data for the existing insurance policy from the ceding carrier 14. Traditionally, operations equivalent to stage 204 can also require time (e.g., half a day) and problems can also arise, such as inconsistencies in data usages between the ceding carrier 14 and the gaining carrier 18.

Stage 206 (new order entry) comprises step 242. In step 242 the distributor 16 enters data to order the new insurance policy from the gaining carrier 18. Traditionally, operations equivalent to stage 206 can also require time (e.g., half a day) and problems can also arise, such as what are the standards and definitions of an order being “in good order” (IGO) and being “not in good order” (NIGO).

Stage 208 (distributor order review) comprises step 244. In step 244 the distributor 16 performs overall order review and determines whether their order is IGO or NIGO. Traditionally, operations equivalent to stage 208 can also require time (e.g., two days) and problems can again arise, such as the definitions of IGO or NIGO. The inventor's company's products can also be used here be used to reduce time and problems. For example, these products can facilitate communications for internal review and signature gathering.

If the order is determined to be NIGO in stage 208, stage 210 follows. Stage 210 (order rework) comprises step 246. In step 246 the distributor 16 revises their order as needed to address the NIGO condition.

If stage 210 was needed, the inventors prefer that stage 212 follows. Stage 212 (advisor statusing) comprises step 248. In step 248 the distributor 16 posts status information about the order, and then the process 200 returns to stage 202 at step 238. Traditionally, operations equivalent to stage 212 can also require time (varying considerably on a case by case basis) and problems can arise, such as the standards and definitions of what constitutes NIGO, with multiple edits sometimes being necessary.

Alternately, if the order is determined to be IGO in stage 208, stage 214 follows. Stage 214 (document conveying) comprises step 250. In step 250 the distributor 16 sends documents for the order to the gaining carrier 18. Traditionally, industry practice has been to send paperwork via fax, postal mail, courier, etc. This takes time (e.g., half a day or longer) and problems here can be the lack of one or more signatures, the lack of needed attachments, and the lack of automated money settlement through the DTCC.

Stage 216 (carrier processing) here comprises step 252, which is performed by the gaining carrier 18 and the ceding carrier 14. A detailed discussion of step 252 is deferred until the discussion of FIG. 3, where it is covered as a sub-process 300. In general, however, there is one entry (A) into step 252 and there are three potential exits (B), (C), or (D). The advisor dashboard in stage 212 at step 248 can also be kept appraised of the status throughout step 252, as shown.

If the gaining carrier 18 does not approve the order, exit (B) is taken and the process 200 proceeds as shown. That is, the order is returned to the distributor 16 for suitable further processing in stage 208. Alternately, if there has been conservation by the ceding carrier 14, exit (D) is taken and the process 200 proceeds as shown, to step 258 where the process 200 ends and any desired wrap-up and post-process work are preformed. Yet alternately, if the gaining carrier 18 approves the order (and there has not been conservation by the ceding carrier 14), exit (C) is taken.

If exit (C) was taken in stage 216, optional stage 218 may follow. Stage 218 (DTCC processing) comprises step 254, where the DTCC 20 may be used to wrap-up the replacement insurance policy exchange. Again, the DTCC is a trusted financial intermediary. It is used in the industry as the hub in the center of transactions where the various other parties are spokes.

Stage 220 (distributor notification) is also optional, and here comprises step 256. In step 256 the DTCC 20 affirmatively provides the distributor 16 with notification that the order has been completed, and then the process 200 ends in step 258.

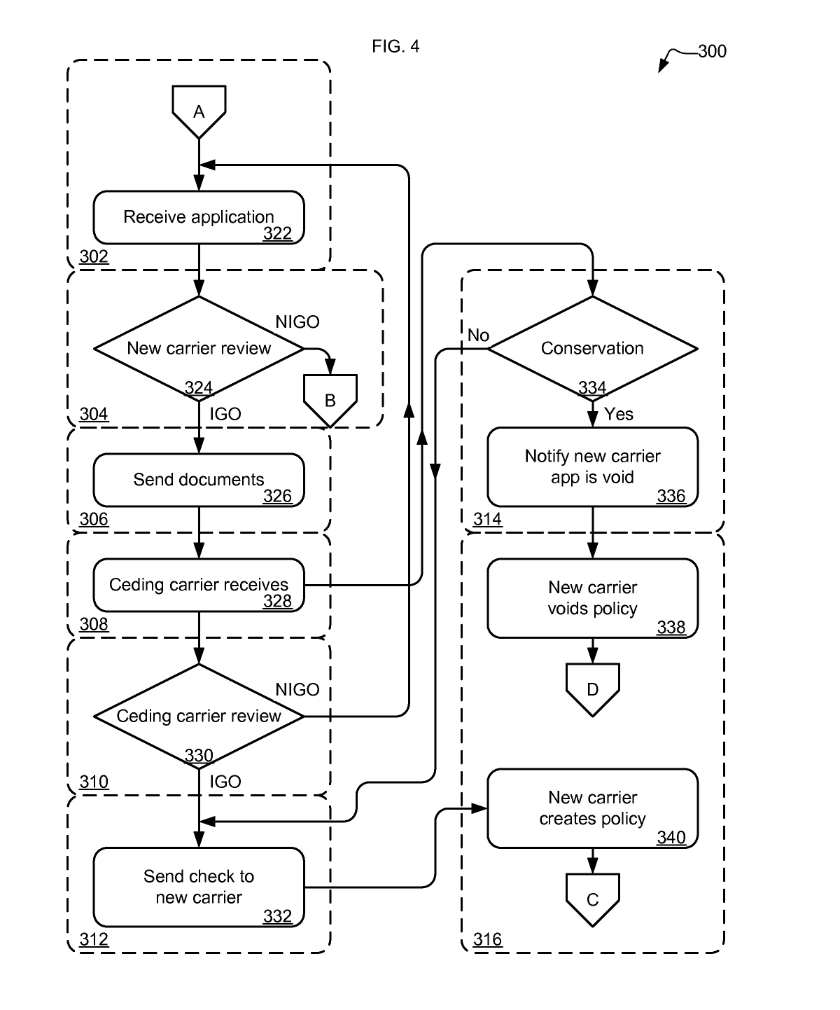

FIG. 4 is a flowchart showing an overview of step 252 in the replacement policy process 200 in FIG. 3, shown here in FIG. 4 as a sub-process 300 particularly employing the inventive IESD 100. For the sake of this discussion, the sub-process 300 is also depicted here as having a set of major stages that are each performed by the various entities (here just the gaining carrier 18 and the ceding carrier 14). The stages are stage 302 through stage 316. Stage 302 is receipt by the gaining carrier 18 of the order (from the distributor 16). Stage 304 is review of the order by the gaining carrier 18. Stage 306 is documents conveying from the gaining carrier 18 to the ceding carrier 14. Stage 308 is receipt of the documents by the ceding carrier 14 (from the gaining carrier 18). Stage 310 is review of the documents by the ceding carrier 14. Stage 312 is (optional) sending of (recoupment) funds by the ceding carrier 14 to the gaining carrier 18. Stage 314 is (optional) conservation by the ceding carrier 14. And stage 316 is policy issuance or order voiding by the gaining carrier 18.

The sub-process 300 and its stages 302-316 are also further depicted as having various steps (e.g., steps 322-340, as shown). The stages here can also can include single steps, multiple steps, or even be optional. Those of ordinary skill in the art will, here as well, appreciate that these demarcations are somewhat arbitrary and that fewer or additional stages and steps may be employed without deviating from the spirit of the invention.

The sub-process 300 is entered at stage 302 (order receipt), where in step 322 the gaining carrier 18 receives the order from the distributor 16. As was discussed with regard to the process 200, stage 214, and step 250, products of the inventor's company can be used to reduce handling time and problems. For example, application programming interfaces (APIs) for these products can be used to facilitate order entry into the systems employed by the gaining carrier 18. Traditionally, operations similar to those in stage 302 have been performed partly or entirely manually, typically requiring half a day to perform and often encountering problems related to signatures and in dealing with multiple administrative systems.

Stage 304 (gaining carrier review) comprises step 324. In step 324 the gaining carrier 18 reviews the order. If the order is determined to be NIGO, the sub-process 300 returns to the process 200, i.e., takes exit (B) to stage 208 at step 244. Alternately, if the order is determined to be IGO, the sub-process 300 continues as shown. Again, products of the present inventor's company can be used here to reduce handling time and problems. Traditionally, operations similar to those in stage 304 have also been performed partly or entirely manually, typically requiring three days to perform and often encountering problems related to proprietary forms; forms routing; the lack of facsimile or other electronic communications systems, or information needed to use these; and to the definitions of what constitute an order being IGO and NIGO.

Stage 306 (convey documents to the ceding carrier) comprises step 326. In step 326 the gaining carrier 18 sends the necessary documents to the ceding carrier 14 to inform it that the gaining carrier 18 has an order to succeed as the insurer. Traditionally this has been done via mail, courier, or facsimile.

Stage 308 (ceding carrier documents receipt) comprises step 328. In step 328 the ceding carrier 14 receives the documents from the gaining carrier 18. Although step 328 may appear simple in FIG. 3 it can be quite complex in practice, depending on the choices and internal processes of the ceding carrier 14. For instance, the ceding carrier 14 may want to try to “conserve” its business relationship with the (policy holder) client 12, by continuing with the existing policy or a different one. If so, stage 314 will follow. Alternately, if the ceding carrier 14 does not want to consider conservation, stage 310 will follow. Traditionally, operations similar to those in stage 308 can require five days or more to perform and can encounter problems related to conducting market review, signatures, the definitions of IGO and NIGO, and dealing with multiple administrative systems. Note, if the ceding carrier 14 wants to consider conservation, it will typically start its processes for this as soon as possible (ASAP), before or concurrent with the documents review in stage 310.

Stage 310 (ceding carrier review) comprises step 330. In step 310 the ceding carrier 14 determines whether the documents received from the gaining carrier 18 in step 328 are IGO or NIGO. If NIGO, the sub-process 300 returns to stage 302 and step 322, for the gaining carrier 18 to correct the problem. If IGO, stage 312 follows. Traditionally, operations similar to those in stage 310 can require ten days to perform and can encounter problems such as whether the (policy holder) client 12 is online, responds promptly and correctly to inquiries, etc.

Stage 312 (ceding carrier sends funds to gaining carrier) comprises step 332. In step 332 the ceding carrier 14 sends any appropriate client funds and/or communicates to the gaining carrier 18 that it is ceding the client 12. Note, stage 312 and step 332 can also follow stage 314, as discussed presently. Traditionally, operations similar to those in stage 312 can require five days to perform and can encounter problems such as whether there are funds due, in what amount, what recoupment rules are applicable, and even if there are standards for such rules.

Stage 314 (ceding carrier conservation) comprises steps 334-336. In step 334 the ceding carrier 14 may conserve its relationship with the client 12. Determining whether this is possible and accomplishing it can take considerable time, e.g., 14 days, and can entail considerable analysis. For instance, the ceding carrier 14 will typically want to determine whether the relationship can be conserved at all, and then whether that will be counterproductive (e.g., not profitable). If the ceding carrier 14 does conserve, in step 336 it notifies the gaining carrier 18 accordingly, and stage 316 follows, as described presently. Alternately, if the ceding carrier 14 does not conserve, the sub-process 300 proceeds to stage 312 and step 332, as described above.

Stage 316 (gaining carrier policy issuance or order voiding) comprises steps 338-340, one or the other. If the ceding carrier 14 conserved in stage 314, in step 338 the gaining carrier 18 voids the order and returns to process 200, i.e., takes exit (D). Alternately, if stage 316 is entered from stage 312, in step 340 the gaining carrier 18 creates the new policy and returns to process 200, i.e., takes exit (C).

Summarizing, the present inventor has implemented the IESD 100 as a cloud-based dashboard (the insurance exchange system dashboard, also termed simply the “iSign Exchange”). The IESD 100 can be used throughout the IES 10, that is, throughout the process 200. Or the IESD 100 can be used only in stage 216 of the process 200, that is, only in the sub-process 300.

As an example of the IESD 100 used throughout the IES 10, say that the ceding carrier 14, distributor 16, and gaining carrier 18 are all participating entities 108a. The distributor 16 then can use the IESD 100 to construct its order, typically by using a template already in the IESD 100 that is based on preferences and requirements of the gaining carrier 18. Indeed, multiple templates all based on those preferences and requirements may be provided in the IESD 100 and the distributor 16 can use one that is additionally based on the preferences and requirements of the ceding carrier, to ensure that as much as possible will be IGO in the order as well as in the relinquishment request that the gaining carrier 18 will send to the ceding carrier 14.

As another example of the IESD 100 used throughout the IES 10, say that only the gaining carrier 18 is a participating entity 108a. The gaining carrier 18 then can accept orders from distributors 16 (non-participating entities 108b) in at least three manners. A distributor 16 can construct the order as it sees fit, and submit it to the gaining carrier 18. The gaining carrier 18 then has the daunting task of entering data into its systems, and then requesting corrections, additions, elaborations etc. until the initial order is IGO. This approach has obvious disadvantages, especially when a gaining carrier 18 has to work with many distributors 16. In most existing uses of an IES 10, a gaining carrier 18 will provide a tool or tools to avoid this. For instance, a gaining carrier 18 may provide a template to distributors 16, or a gaining carrier 18 may provide a proprietary order entry system for use by distributors 16. However, even here the inventive IESD 100 can provide substantial improvement over a traditional IES 10. A gaining carrier 18 (the only participating entity 108a in this hypothetical scenario) can provide a very limited “public” access, say, via links on its website, to its tools (e.g., templates, documents, help files, etc.) for use by distributors 16. Alternately, a distributor 16 can communicate (e.g., via email, text message, even verbally in a telephone call) to a participating entity 108a that it wants to place an order, and then the participating entity 108a can send that distributor a link into appropriate portions of the IESD 100. As discussed above, when such links are provided by a participating entity 108a, non-participating entities 108b can also use the IESD 100.

As an example of the IESD 100 used only in stage 216 of the process 200 (only in the sub-process 300), say again that only the gaining carrier 18 is a participating entity 108a, that is, that the ceding carrier 14 is a non-participating entity 108b. The gaining carrier 18 can directly and easily construct the relinquishment request and any other desired document using the IESD 100. In fact, if the ceding carrier 14 is of any significance in the industry, the IESD 100 may full well have templates specific to it even though it is not a participating entity 108a. Or the IESD 100 may have a generic or semi-generic template that the gaining carrier 18 can use with minor changes appropriate for the particular ceding carrier 14 and order scenario. The gaining carrier 18 can then send the constructed relinquishment request to the ceding carrier 14 using the IESD 100. In particular, the IESD 100 can include links in the relinquishment request or any other documents it is used to send, and the particular ceding carrier 14 (non-participating entity 108b) can then use the IESD 100 as appropriate here.

And as a last example here, of the IESD 100 used only in stage 216 of the process 200 (only in the sub-process 300), consider the case where both the gaining carrier 18 and the ceding carrier 14 are participating entities 108a. The gaining carrier 18 uses the IESD 100 to construct and place the relinquishment request and any other desired documents, which is easy because the IESD 100 here includes templates, help guidance, and other resources specific to both the gaining carrier 18 and the ceding carrier 14. As participating entities 108a the gaining carrier 18 and the ceding carrier 14 do not even have to send links or document copies to each other. They can if they wish, but they also can let everything “reside” in the IESD 100 and be worked on there. Documents can be constructed, stored, edited, signed, etc. all within the IESD 100.

There is a semantic awkwardness with the term “send” in the context of the IESD 100, and the term “place” may be preferable. Traditionally, a document is physical, is present in its entirety, and when sent is sent as an entire document from one geographic location to another. These are not requirements with electronic documents. For example, a first entity today can “place” an electronic document on server, where a second entity can then access that document and retrieve (i.e., download) the entire document, or only retrieve a portion of it (e.g., a single table, figure, or page, or a chapter or appendix).

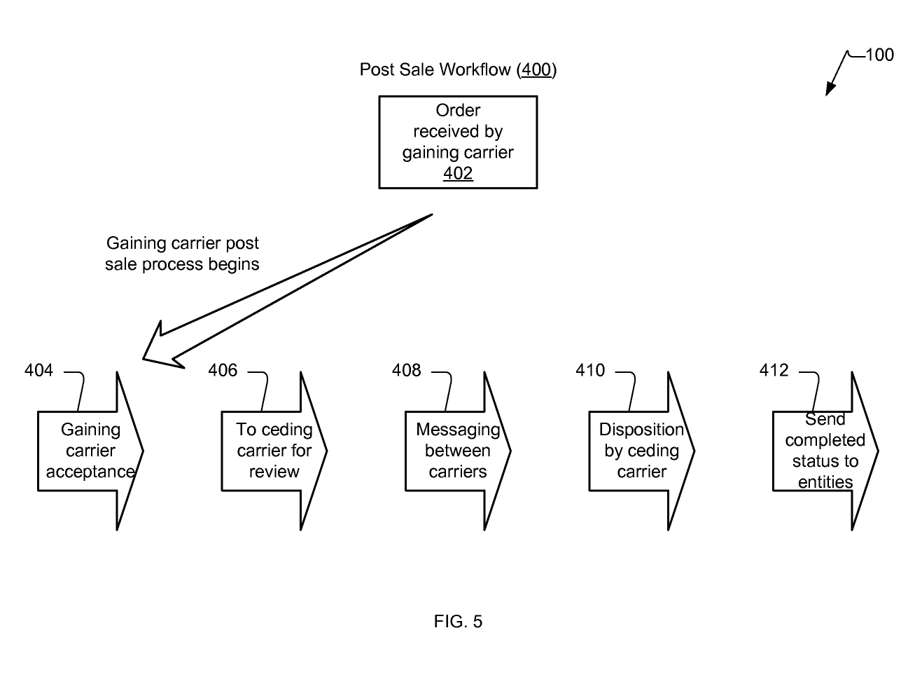

Before proceeding with discussion of the IESD 100 implemented as a dashboard, FIG. 5 is a stylized block diagram that recaps and shows an overview of post sale workflow 400 in the IESD 100. At a stage 402 the order has been received by the gaining carrier 18 and is IGO. At a stage 404 the gaining carrier 18 accepts the order. At a stage 406 the gaining carrier 18 sends documents, that is, a relinquishment request, to the ceding carrier 14. At a stage 408 any necessary or desired messaging between the ceding carrier 14 and the gaining carrier 18 occurs. At a stage 410 the ceding carrier 14 sends a disposition (approval/rejection) to the gaining carrier 18. And at a stage 412 the gaining carrier 18 competes and wraps-up handling the order (completing it or voiding it).

The IESD 100 here automates the exchange of documents, messaging, and status reporting. It can be implemented in a secure computing/networked cloud environment. It can have effectively zero integration requirements. It has no particular hardware, browser, installation, or device requirements. It can provide one site for status, messaging, templates and legally binding forms for the participating entities 108a, and it can permit participation by non-participating entities 108b to complete, review, inquire, reject, sign, etc. email links. It can permit mobile and remote review and signing. It can permit sending signed forms, and status and audit detail in XML to the entities 108, while accepting legally binding signatures and accumulating a full audit trail. And throughout this the IESD 100 can be very cost efficient.

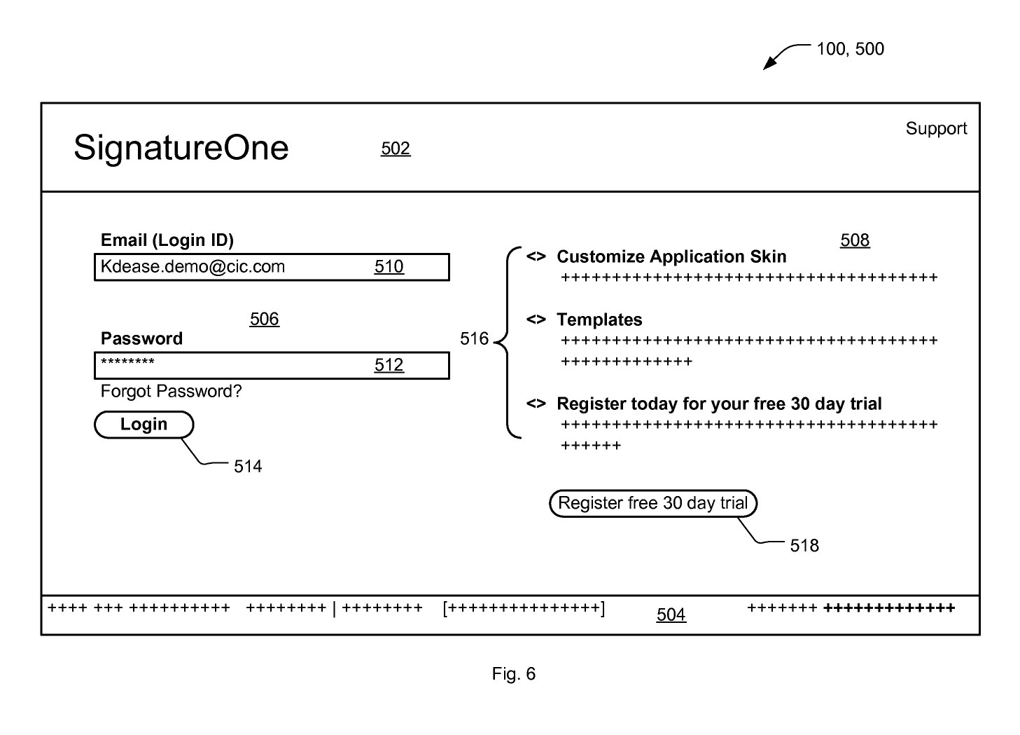

FIG. 6 shows a participating entity 108a user's view of a login screen 500 of an exemplary embodiment the IESD 100. The login screen 500 includes typical top-bar elements 502 and bottom-bar elements 504. These are kept simple here, with the top-bar elements 502 including an operator brand field and a link to a support functionality and with the bottom-bar elements 504 including a copyright field, links to other legal-related functionality, and other information fields. In particular the login screen 500 includes a login section 506 and a features section 508. The login section 506 has conventional login controls, including a login ID field 510, a password field 512, and a login button 514. The features section 508 has very brief information of interest 516 to a first-time, unregistered user and a register button 518.

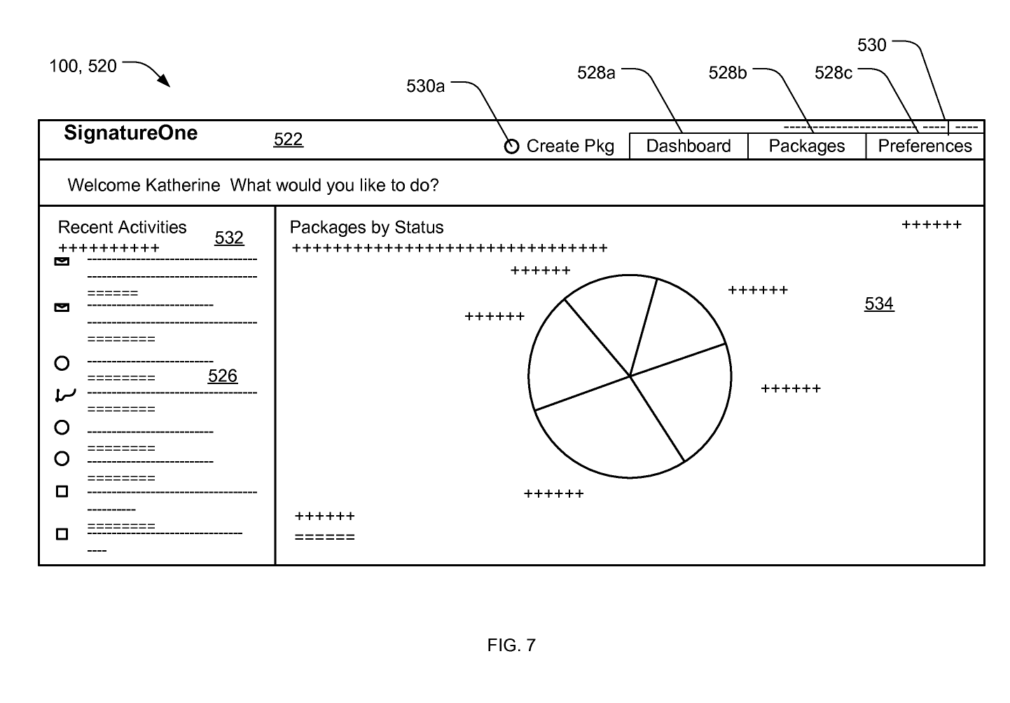

FIG. 7 shows an entity 108 user's view of a operational screen 520 of the embodiment the IESD 100 in FIG. 6, once a participating entity 108a has logged in or once a non-participating entity 108b has activated a link in for entry. The content of the operational screen 520 will typically vary somewhat based on whether the user is a participating entity 108a or non-participating entity 108b. The participating entity 108a can set either of two general options for what non-participating entities 108b will see. The IESD 100 can be configured to show as much appropriate detail as possible, deactivating controls as necessary but nonetheless showing them as gray'ed out. Showing non-participating entities 108b the power and scope of the IESD 100 in this manner thus provides them with an incentive to become participating entities 108a. Alternately, the participating entity 108a can configure the IESD 100 to show only relevant detail and activated controls to non-participating entities 108b.

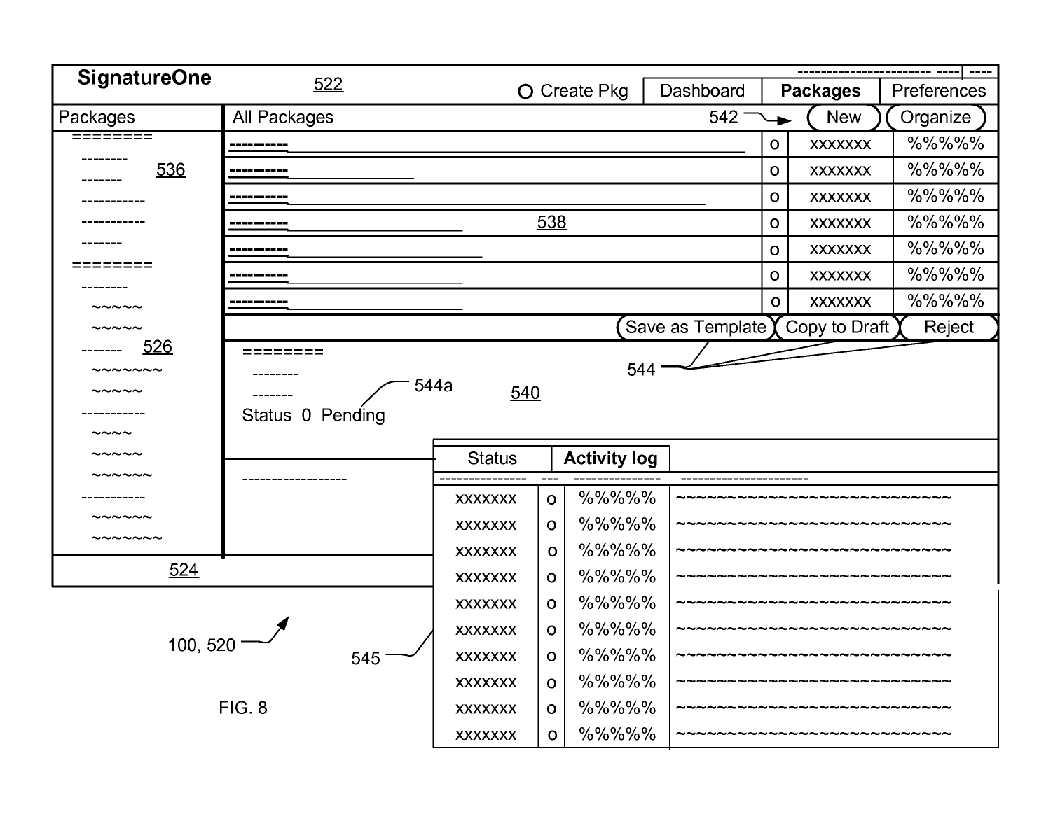

In FIG. 7 the user is the same person who logged in in FIG. 6, and thus is a participating entity 108a. The operational screen 520 preferably also has top-bar elements 522 and bottom-bar elements 524 (not-shown, see e.g., FIG. 8; these may be the same as bottom-bar elements 504), as well as a work region 526. The top-bar elements 522 here resemble those in the login screen 500 only with the addition of logged in user ID information, a logout link, functionality tabs 528, and optional controls 530. Some optional controls 530 may appear only when a particular functionality tab 528 is active, e.g., the create package button 530a here. In the operational screen 520 here there are three functionality tabs 528, based on the functionalities granted to the currently logged in user. Here these are a dashboard tab 528a; that accesses informational functionality in the IESD 100; a packages tab 528b, that accesses documents functionality in the IESD 100; and a preferences tab 528c, that accesses preferences functionality in the IESD 100. Additional functionality tabs 528 might optionally be present, say, if the current user was system administrator. Again, the bottom-bar elements 524 here may be the same as the bottom-bar elements 504 in the login screen 500.

The work region 526 of the operational screen 520 here contains features appropriate to the dashboard tab 526a. These include a recent activities region 532 and a packages by status region 534 (here showing a pie chart). The dashboard tab 526a can be used to answer questions like: What status is my contract? Has the officer approved or rejected it? Has the order expired? Has the order completed all signatures? Or is there any missing data the ceding carrier needs?

FIG. 8 shows an alternate view of the operational screen 520, here once the packages tab 528b is active. The top-bar elements 522 here are the same (the create package button 530a could alternately be absent or grayed out and non-operable if the current user did not have appropriate authorization for this; and the create package button 530a typically would not appear if the preferences tab 528c was active. The work region 526 of the operational screen 520 now contains features appropriate to the packages tab 528b. These include a packages sidebar 536 for selecting a package type, here appearing leftmost; a packages region 538 for selecting a specific package, here appearing upper rightmost; and a (selected) package region 540 for viewing a selected package, here appearing below the packages region 538.

The packages sidebar 536 here shows the types of packages available to the currently logged in user to work with. Again, non-authorized choices may not be presented or may be but then be grayed and non operable, say, as a matter of system administrator configuration or by the user's own configuration in the preferences tab 528c. The types of main packages available here include All Packages and Templates, with All Packages having sub-choices available for Draft, Pending, Completed, Rejected, and Expired packages and Templates having sub-choices available for templates for specific corporate users of the IESD 100.

The packages region 538 here shows a listing of the packages under the current main package or sub-choice, as well as controls 542 appropriate for working with these. The package region 540 shows a currently selected package as well as controls 544 appropriate for working with this (including a package status button 544a that brings up an activity log window 545. The packages tab 528b thus shows features for: tracking status, messaging to communicate with carriers on package details (review/reject), update and resend package status, and attaching additional documents.

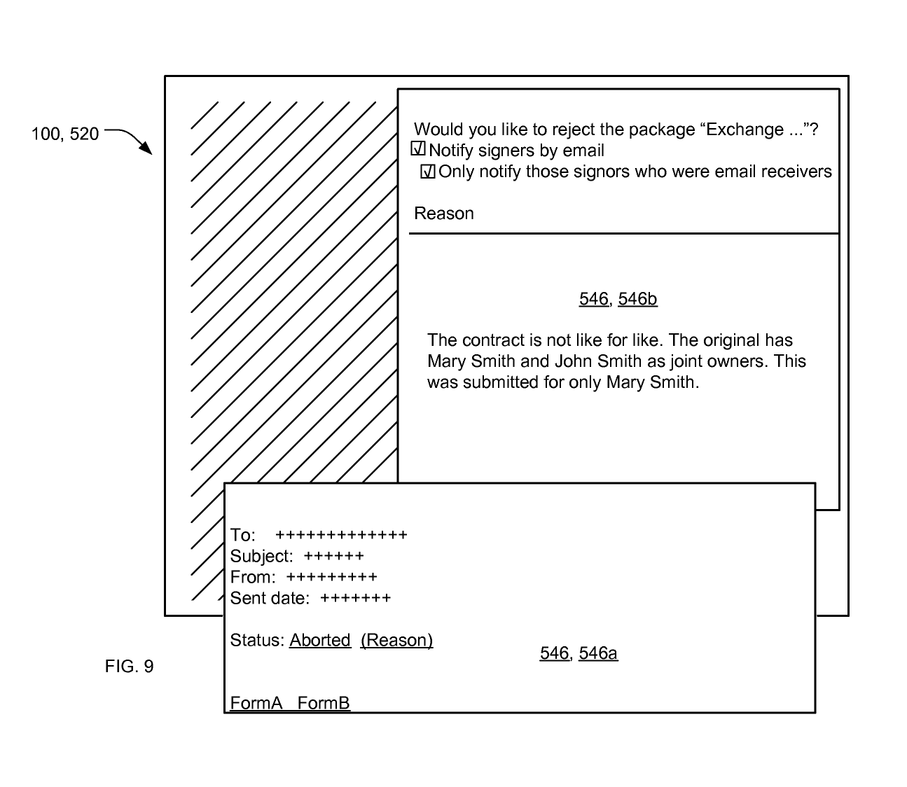

FIG. 9 shows an alternate view of the operational screen 520, in the packages tab 528b, now with two pop-up windows 546 active. The user has operated the package status button 544a and changed the status from pending to aborted (rejected). One of the pop-up windows 546 is a pending package region window 546a showing what the package region will change to once the user completes the current operation. The other pop-up window 546 is a message window 546b showing a template based message that the user is completing to send to affected parties. For instance, the message window 546b can contain controls to specify who the message will be sent to and an explanation. In the particular scenario underlying FIG. 9, the user is sending a message that the proposed new policy order lists the client 12 as an individual and the original policy lists joint owners as the client 12. This is message that a ceding carrier 14 might send internally and to a gaining carrier 18.

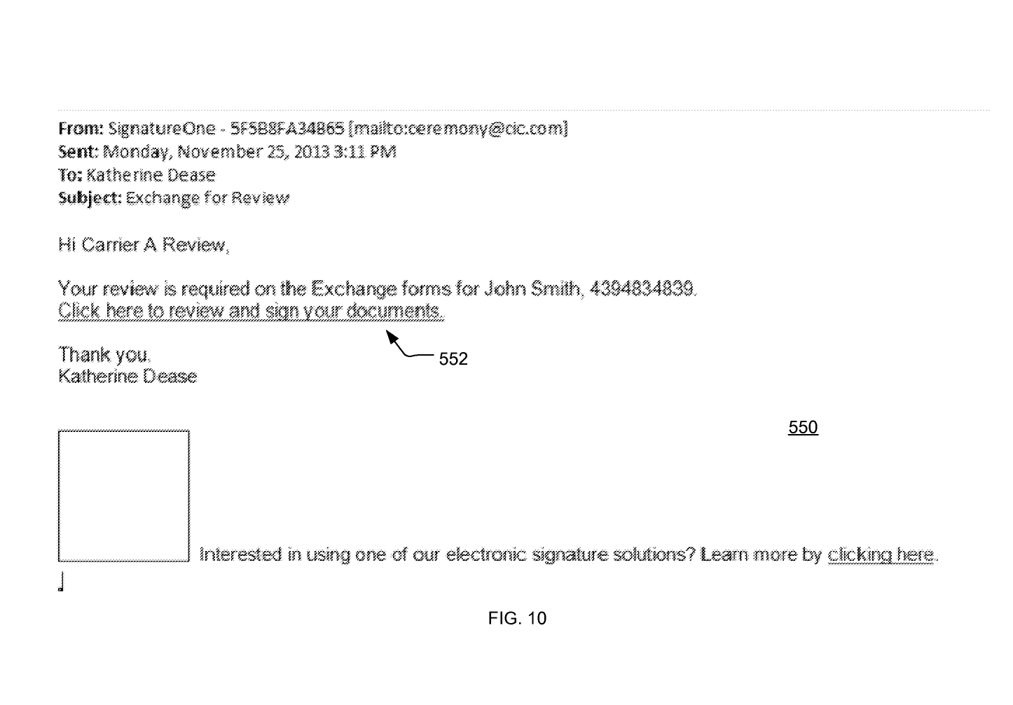

FIG. 10 shows a non-participating entity 108b view of an exemplary message 550 received via the IESD 100 through e-mail. In particular, the message 550 includes a link 552 that the recipient can use to access the IESD 100. The scenario underlying FIG. 10 follows on that of FIG. 9. This is a message 550 that the gaining carrier 18 (say, a participating entity 108a) might send to the distributor 16 (a non-participating entity 108b) to prompt them for document review and signing by the previously omitted joint owner client 12.

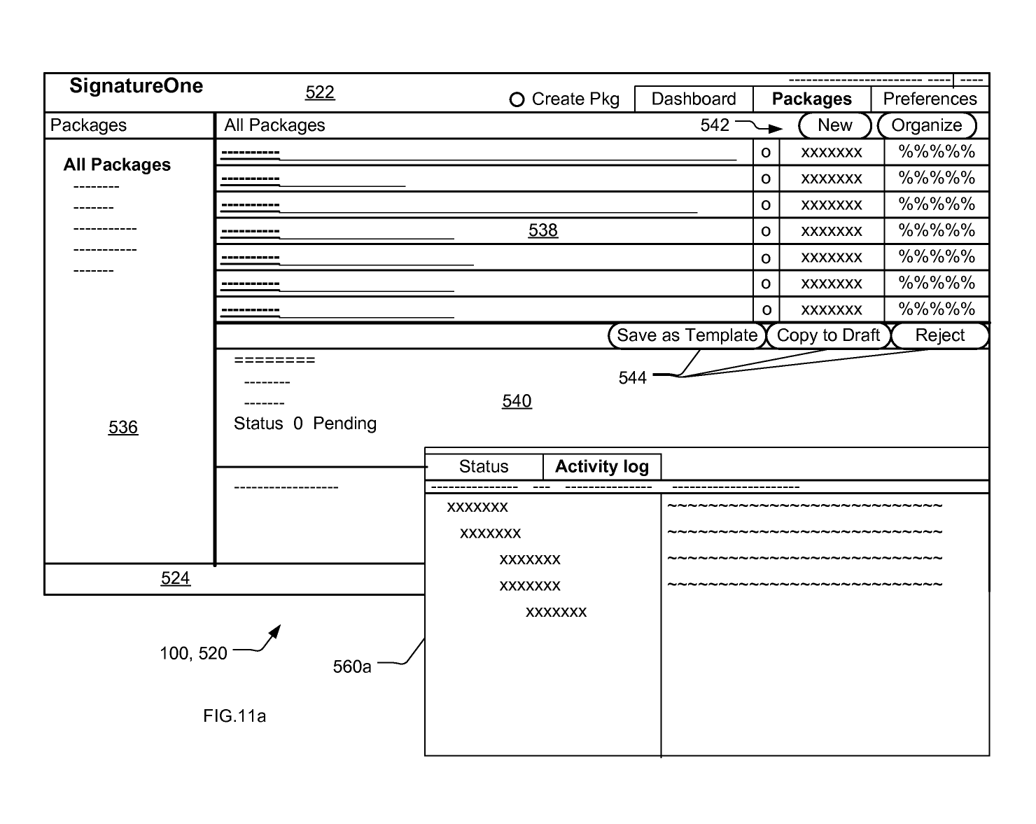

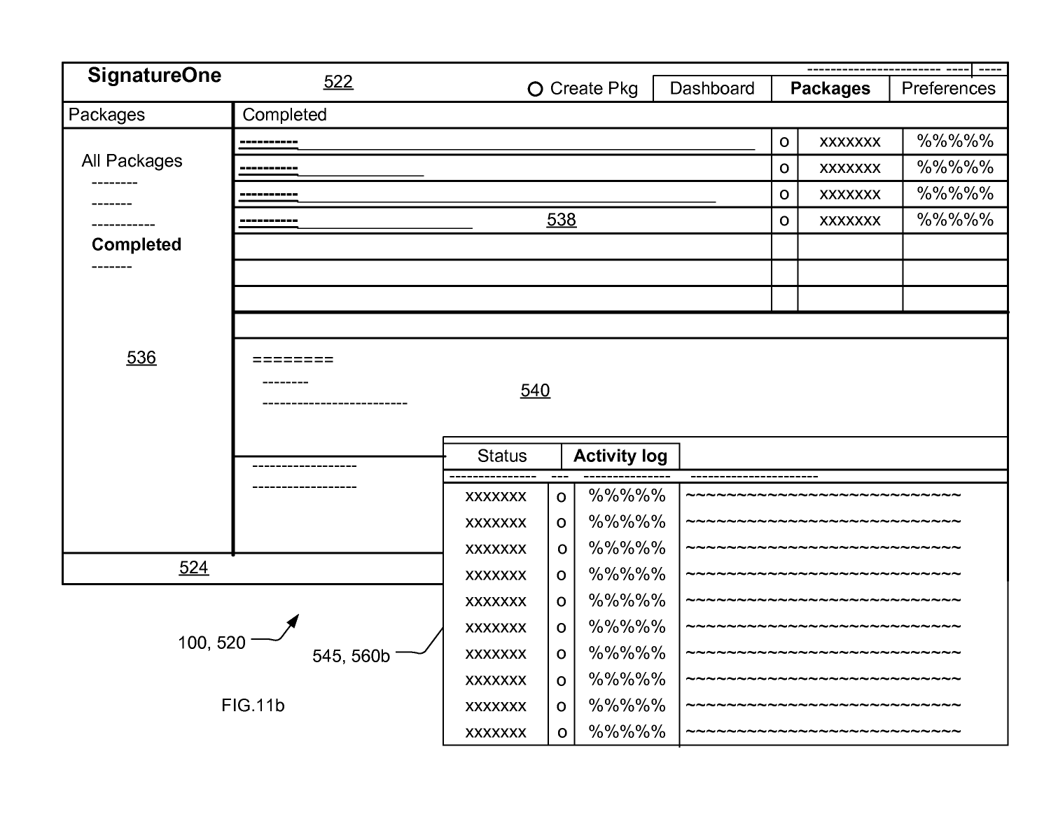

FIGS. 11a-b show pop-up status views 560 overlying the operational screen 520 with the packages tab 528b active in the IESD 100. In FIG. 11a the All Packages option has been selected in the packages sidebar 536, the topmost package in the packages region 538 has been selected (or was simply came up by default, say, if it is topmost due to most recent activity by the logged in user). The user has double clicked on this package and a status view 560a has popped-up. that shows an activity log, that is, an audit trail. In FIG. 11b the Completed sub-option has been selected in the packages sidebar 536, the topmost package in the packages region 538 now has been selected (or defaulted to), the user has double clicked on this package, and now an activity log view 560b has popped-up (the activity log window 545 again).

From FIGS. 11a-b it can be appreciated that the IESD 100 can make a detailed audit trail available in its dashboard. Application programming interfaces (APIs) can be provided and used here to automate the download of signed forms and the audit trail into the in-house systems of entities 108.

In summary regarding the post sale benefits of the IESD 100, It provides a one-stop capability to track status, receive acceptance, communicate with ceding carriers 14, update packages, and send statuses to the DTCC 20. Participation has a low cost. It has essentially zero integration requirements. Workflow allows both carriers 14, 18 to review and/or reject exchanges regardless of their participation as registered entities 108. It is scalable for gaining carriers 18 with DTCC 20 replacements. It reduces expenses for automating status and messaging, reduces time, manual tracking, and paper hassle, automate downstream processing, and provides for legally binding signatures and a detailed audit log.

What is claimed is:

1. A process for insurance policy exchange wherein a client has an existing policy issued by a ceding carrier and a distributor has an application from the client for a replacement policy to replace the existing insurance policy, the process comprising:
(a) by the distributor, employing an insurance exchange system dashboard to construct and place an order for the replacement policy to a gaining carrier, wherein said order includes signed client transfer forms and replacement policy details;
(b) by the gaining carrier, reviewing said replacement policy details to determine whether to accept said order;
(c) by the gaining carrier, employing said insurance exchange system dashboard to construct and place a relinquishment request to the ceding carrier, wherein said relinquishment request informs the ceding carrier that the gaining carrier has the order for the replacement policy and includes said signed client transfer forms;
(d) by the ceding carrier, reviewing said relinquishment request to determine whether to approve or reject said relinquishment request;
(e) by the ceding carrier, employing said insurance exchange system dashboard to construct and place a disposition to the gaining carrier, wherein said disposition includes an approval or a rejection of said relinquishment request;
(f) by the gaining carrier, reviewing said disposition and accepting said order from the distributor if said disposition includes an approval, or rejecting said order from the distributor if said disposition includes a rejection;
(g) by the gaining carrier, communicating to the distributor said accepting or said rejecting of said order; and wherein
said insurance exchange system dashboard is a server computerized system hosted on a global communications network and provides templates for constructing said order, said relinquishment request, and said disposition.

2. The process of claim 1, wherein:
at least one of said order, said relinquishment request, and said disposition requires an electronic signature.

3. The process of claim 1, wherein:
said (b) includes the gaining carrier determining and communicating to the distributor whether said order is in good order (IGO); and
said (a) and said (b) are performed iteratively until the order is IGO.

4. The process of claim 1, wherein said (d) includes the ceding carrier analyzing said relinquishment request to determine if conservation is appropriate and communicating with the client to request said conservation.

5. The process of claim 1, wherein said (g) employs the depository trust & clearing corporation (DTCC).

6. A process for insurance policy exchange wherein a client has an existing policy issued by a ceding carrier and a distributor has an application from the client for a replacement policy to replace the existing insurance policy and the distributor has placed an order for the replacement policy with a gaining carrier, the process comprising:
(a) by the gaining carrier, employing an insurance exchange system dashboard to construct and place a relinquishment request to the ceding carrier, wherein said relinquishment request informs the ceding carrier that the gaining carrier has the order for the replacement policy and includes a transfer form signed by the client;
(b) by the ceding carrier, reviewing said relinquishment request to determine whether to approve or reject said relinquishment request; and
(c) by the ceding carrier, employing said insurance exchange system dashboard to construct and place a disposition to the gaining carrier, wherein said disposition includes an approval or a rejection of said relinquishment request; and wherein
said insurance exchange system dashboard is a server computerized system hosted on a global communications network and provides templates for constructing said relinquishment request and said disposition.

7. The process of claim 6, wherein:
at least one of the order, said relinquishment request, and said disposition requires an electronic signature.

8. The process of claim 6, wherein:
said (b) includes the ceding carrier determining and communicating to the gaining carrier whether said relinquishment request is in good order (IGO); and
said (a) and said (b) are performed iteratively until said relinquishment request is IGO.

9. The process of claim 6, further comprising:
(d) the gaining carrier determining and communicating to the ceding carrier whether said disposition is in good order (IGO); and wherein
said (c) and said (d) are performed iteratively until the said disposition is IGO.

10. The process of claim 6, wherein said (d) includes the ceding carrier analyzing said relinquishment request to determine if conservation is appropriate and communicating with the client to request said conservation.

11. A computer program, embodied on a tangible, non-transitory computer readable storage medium, for insurance policy exchange wherein a client has an existing policy issued by a ceding carrier and a distributor has an application from the client for a replacement policy to replace the existing insurance policy and the distributor has placed an order for the replacement policy with a gaining carrier, the computer program comprising:
a code segment that permits the gaining carrier to employ the insurance exchange system dashboard to construct and place a relinquishment request to the ceding carrier, wherein said relinquishment request informs the ceding carrier that the gaining carrier has the order for the replacement policy and includes signed client transfer forms;
a code segment that permits the ceding carrier to review said relinquishment request to determine whether to approve or reject said relinquishment request; and
a code segment that permits the ceding carrier to employ the insurance exchange system dashboard to construct and place a disposition to the gaining carrier, wherein said disposition includes an approval or a rejection of said relinquishment request; and wherein
said insurance exchange system dashboard is a server computerized system hosted on a global communications network and provides templates for constructing said relinquishment request and said disposition.

12. The computer program of claim 11, further comprising:
a code segment that permits the distributor to employ the insurance exchange system dashboard to construct and place the order for the replacement policy to the gaining carrier, wherein the order includes replacement policy details and said signed client transfer forms; and
a code segment that permits the gaining carrier to review said replacement policy details to determine whether to accept the order.

13. The computer program of claim 11, wherein:
at least one of the order, said relinquishment request, and said disposition requires an electronic signature; and further comprising:
a code segment that permits affixing said electronic signature to respective of the order, said relinquishment request, or said disposition.

14. The computer program of claim 11, wherein:
at least one of the order, said relinquishment request, and said disposition are an electronic document;
the insurance exchange system dashboard is used by entities that are participating entities and non-participating entities;
and the computer program further comprising:
a code segment that inserts a link to a said electronic document into a message; and
a code segment that communicates said message to a said entity, thereby
allowing access to the insurance exchange system dashboard by both a said participating entity as well as a said non-participating entity.

15. The computer program of claim 11, further comprising:
a code segment that communicates with the client to request conservation.

16. The computer program of claim 15, further comprising:
a code segment that sets a reminder or expiration based on a period for conservation.

17. The computer program of claim 11, further comprising:
a code segment that communicates with the depository trust & clearing corporation (DTCC).
